(19) United States
(12) Patent Application Publication
(10) Pub. No.: US 2004/0231452 A1
(43) Pub. Date: Nov. 25, 2004

(54) Device for opening a bearing arrangement

(76) Inventors: Andre Burgstaler, Dielingen (DE); Jan Dutz, Damme (DE); Simone Papke, Osnabruck (DE)

Correspondence Address: McGlew & Tuttle, Scarborough Station, Scarborough, NY, 10510-0827, US

(21) Appl. No.: 10/480,394

(22) PCT Filed: Feb. 12, 2003
(86) PCT No.: PCT/DE03/00416

(51) Int. Cl. G05G 1/14

(52) U.S. Cl. 74/560

(57) ABSTRACT

A device for opening a mount, especially a pedal bolt mount of a motor vehicle, has at least one first mounting part, which has at least one through hole for a bolt connection with at least one connecting piece, as well as at least one mounting bolt, which extends coaxially through the through hole in order to connect the mounting part and the connecting piece with one another. A structure is provided for destroying the mounting bolt, which opens the mount and thus loosens the connecting piece in order to achieve a safety function, and moves the connecting piece in a guided manner in the direction of the floor of the vehicle. The structure for destroying the mounting bolt and for guiding in a directed manner is designed as at least one separating element supported via a support part. The separating element is guided between the connecting piece and the mounting part and is in positive-locking and nonpositive contact with the mounting bolt in order to destroy the mounting bolt upon the onset of a collision to loosen the mount and to move the connecting piece away in a directed manner.

### FIELD OF THE INVENTION

The present invention pertains to a device for opening a mount, especially a pedal bolt mount of a motor vehicle, with at least one first mounting part, which has at least one through hole for a bolt connection with at least one connecting piece, as well as at least one mounting bolt, which extends coaxially through the through hole in order to connect the mounting part and the connecting piece with one another, wherein means are present which move the connecting piece out of the danger area in a directed manner, i.e., preferably in the direction of the front of the vehicle. Furthermore, means are provided for destroying the mounting bolt, which open the mount and thus loosen the connecting piece in order to guarantee an additional safety function as a result.

### BACKGROUND OF THE INVENTION

Such safety devices are used, among other things, in the leg room of passenger compartments in motor vehicles in conjunction with pedal connections via a bolt to avoid risks for injury because of direct collisions. The risks for injury are due to the fact that the occupants are not able to absorb the accelerating forces occurring during a direct collision, so that, among other things, the lower extremities of the person sitting in the front area are thrown into the leg room. In addition, deformation of the engine compartment indirectly or directly affects the pedals in a collision, and the pedals are moved into the leg room of the motor vehicle. The injuries developing as a result are painful for the person or persons affected and may even lead to lifelong mutilation.

Various solutions have been known from the state of the art for counteracting this circumstance. Two types of safety devices are mainly distinguished. On the one hand, the pedal is prevented from moving in the direction of the interior space of the vehicle by bending or bending away a connecting piece, e.g., the push rod of a brake booster; on the other hand, the pedal is prevented from penetrating into the interior space of the vehicle by opening the pedal mounting site, brought about by deformation, e.g., bending, of structural parts, e.g., sheet metals. The second approach will be pursued further here.

A safety device which prevents the pedal from penetrating into the leg room by opening the pedal mounting point has been known from the patent specification DE 100 40 043. The safety device comprises a bearing block, in which the pedals pivotable around an axis are mounted on bolts which are fixed in the mounts of the bearing block. The bearing block has at least one section which can be widened up, so that the force acting from the outside in a collision leads to a deformation of the front firewall and widens or spreads the bearing block as a consequence. The widening may take place by means of a wedge-shaped element, which is driven in between the legs of a bearing block. The kinetic energy needed for this is obtained from the movement of the motor vehicle parts undergoing deformation in relation to one another in a collision. The bolts mounting the pedals are thus loosened, so that the pedals with their bolt are separated from their mounting and do not penetrate into the leg room. In addition, a pedal hold-down device is present, which ensures that the pedals are guided in the direction of the floor of the vehicle in the case of a crash.

The prior-art safety device has the drawback that the above-described solution has not proved successful in practice because of the great assembly effort. In addition, at least the deformation areas must be made of metallic materials, which causes the mounting part to be relatively heavy. Furthermore, at least one additional component, which ultimately leads to higher costs, is needed to guarantee that the pedals are guided in the direction of the floor of the motor vehicle.

### SUMMARY OF THE INVENTION

The object of the present invention is therefore to provide a device in which a directed movement of the pedal out of the danger area in the direction of the front of the vehicle can be achieved and the opening of the mounting point is reliably guaranteed in order to improve the safety of the occupants of the vehicle, while the assembly effort should be reduced.

The present invention includes the technical teaching that the means for destroying the mounting bolt and for directed guiding are designed as at least one separating element, which is supported via a support part and which is arranged and guided between the connecting piece and the mounting part in order to move the connecting piece out of the danger area in a directed manner and to destroy the mounting bolt and thus to loosen the mount upon the onset of the collision for which they are intended. A positive-locking and/or nonpositive contact may be established between the separating element and the connecting piece for this purpose.

This solution offers the advantage that the solution requires very little installation space due to a simple design and due to guiding between the mounting part and the connecting piece, and the separating part can be mounted easily because of the compact design. Due to the fact that the housing does not require metallic elements, the weight can, moreover, be reduced as a result of the fact that the mounting part is opened by destroying the bolt instead of by bending the housing. Due to an integrated positive-locking element, which guarantees that the connecting piece is moved away in a directed manner, a corresponding component, which would assume this separate task, is eliminated.

Another advantage of the present invention is that the support part is a cross rail of the vehicle, which moves only very little away from its initial position if at all as a consequence of a collision, because reliable triggering of the safety device is thus guaranteed.

Provisions are made in an especially advantageous solution for the separating element to be a separating wedge, where the flow of forces between the separating element and the mounting bolt for destroying the mounting bolt can be achieved via at least one acting surface, whose contour corresponds to the principle of action of a wedge with a curved surface or a geometry converging in a tip-shaped manner in the sense of a sloped plane. Thus, the force for destroying the mounting bolt can be increased in a simple manner.

The connecting piece may advantageously be a pedal lever of a motor vehicle.

Furthermore, the pedal lever may be a brake pedal or a clutch pedal.

Provisions are made, in a measure improving the present invention, for the mounting part to be a plastic bearing block having at least two legs for guiding the separating element. Better guiding of the separating element is guaranteed by the two legs. Due to the fact that the mounting part is designed as a plastic bearing block, it is guaranteed that the mounting part can be made of a material with low own weight at a low cost.

Another measure improving the present invention is that the positive locking connection between the separating element and the mounting bolt for moving away the connecting piece is brought about by means of teeth. It is thus ensured that no separate component is needed to bring about this movement of the connecting piece. Moreover, teeth guarantee the optimal transmission of forces.

The mounting bolt may have undercuts designed as a predetermined breaking point for safety reasons. The safety function is thus additionally guaranteed.

Finally, it is advantageous that the contact between the separating element and the mounting bolt is established by a positive-locking connection and a nonpositive connection one after another, and the separating element first moves the mounting bolt, via positive-locking teeth of the connecting piece, in the direction of the floor of the vehicle in the case of a collision before the mounting bolt is destroyed via the active surface of the separating element in a nonpositive manner. It is thus guaranteed that when the safety function is triggered, the projecting connecting piece is first moved away from the immediate danger area in a directed manner and the mounting point is opened only thereafter in order to thus reduce the risk for injury to a minimum. Other measures improving the present invention are described in greater detail below together with the description of a preferred exemplary embodiment of the present invention on the basis of the figures.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a perspective view of a complete connecting piece mount;

FIG. 2 is a top view of the mount; and

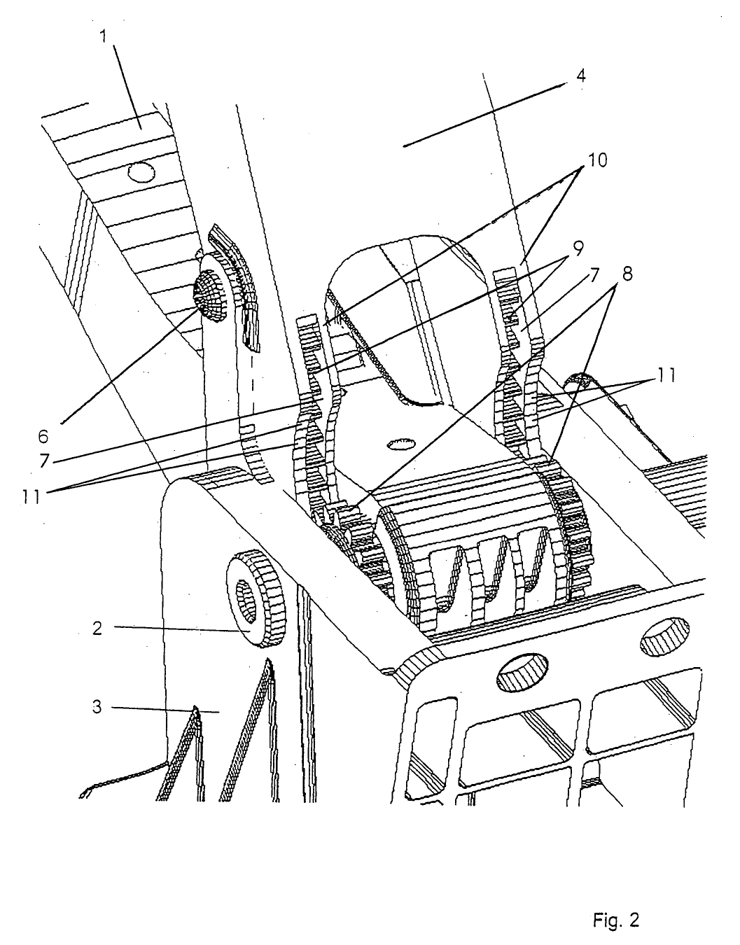

FIG. 3 is a sectional view of the mount.

### DESCRIPTION OF THE PREFERRED EMBODIMENT

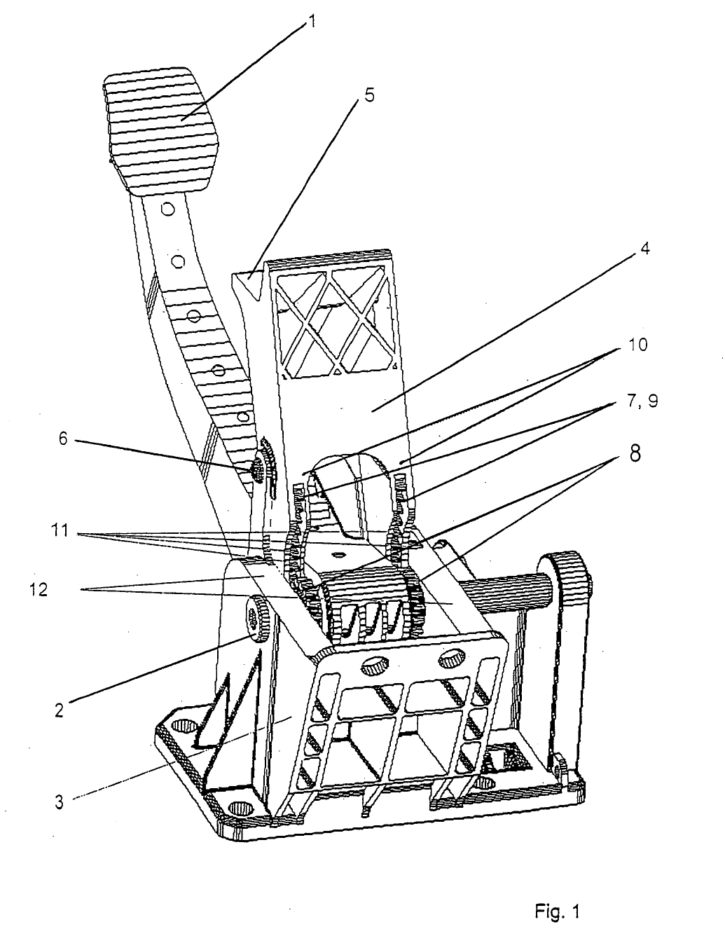

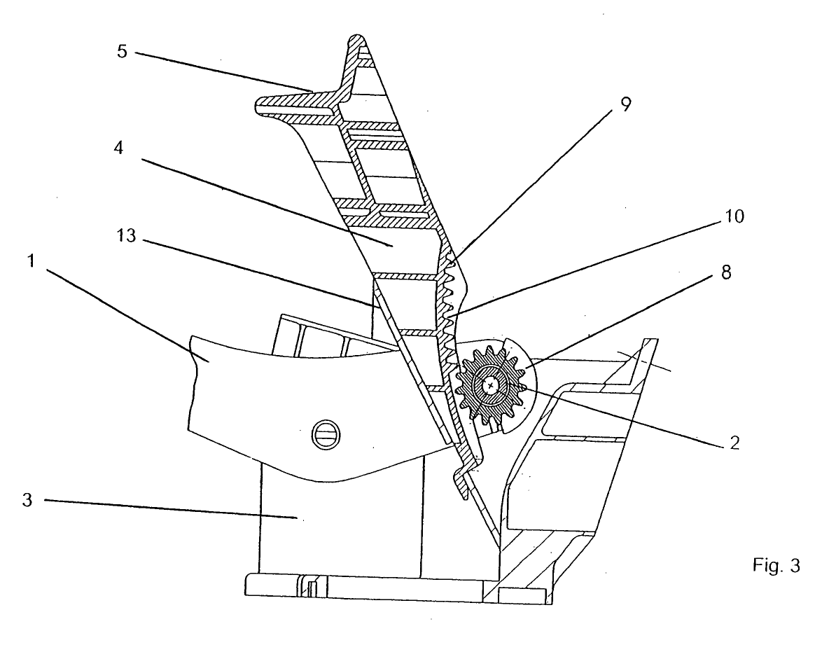

Referring to the drawings in particular, the device shown in FIG. 1 contains a mounting bolt 2 for mounting a connecting piece 1 of a motor vehicle. The connecting piece 1 is accommodated pivotably in a mounting part 3. The connecting piece 1 in the sense of the embodiment is a pedal lever. The mounting part 3, which may be designed as a housing, is fastened to the front wall of the motor vehicle (not shown) in the leg area of the motor vehicle. One section of a separating element 4, which is designed as a separating wedge in the embodiment, and which is supported via a support surface 5 against a motor vehicle component (not shown), is accommodated between a surface 13 of the mounting part 3 designed as a housing and the mounting bolt 2. The motor vehicle component is a cross rail in the preferred embodiment. The cross rail is useful for the contact of the support surface 5 of the separating element 4, more precisely the separating wedge 4, because it is not deformed at all even in serious collisions or is deformed mostly only slightly. As such with support via the cross rail, a reliable, nearly constant support of the separating element 4 is possible. The separating element 4 is connected to the mounting part 3 via a connecting element 6, and the connecting element 6 presents a locking of the separating element 4. This locking is released in the case of a collision by the relative movement between the housing 3 and the separating element 4. In addition, the separating element 4 has two guide gaps 7, which laterally touch the lateral surfaces of teeth 8 of the mounting bolt 2 with their inner sides. The guide gaps 7 are designed such that they project in the form of teeth 9. The teeth 9 are present at the separating element 4 and correspond to the teeth 8 of the mounting bolt 2 and form a lateral guiding without engaging the teeth 8, 9 of the mounting bolt 2 and of the separating element 4. The separating element 4 brings about the shearing off of the mounting bolt 2 as a consequence of an external force acting as a result of a collision due to a relative movement between the separating element 4 and the mounting bolt 2, while a shearing force is applied. The separating element 4 comprises a basic body, with which two parallel legs 10, which have the recessed teeth 9 centrally and the gap 7, are made in one piece. On the side facing the mounting bolt 2, the legs 10 have active surfaces 11 each, which are each designed as an arc-shaped contour according to the preferred embodiment. Under the action of a force, the parallel arrangement of the legs 10 causes the shearing forces to be applied uniformly to two or four different areas of the mounting bolt 2, so that the mounting bolt 2 can be severed with certainty and reliably. The mounting bolt 2 shown passes through two cheeks 12 of the mounting part 3, which are located at spaced locations from each other. The connecting piece 1 is arranged approximately centrally between the cheeks 12 on the mounting bolt 2, so that there is a distance between the connecting piece 1 and the respective cheek 12 on both sides of the connecting piece 1. The teeth 8 are located on the mounting bolt 2 in the region of this distance centrally on each side. These distances form contact areas for the active surfaces 11 of the separating element 4 at the mounting bolt 2. The distances should not be substantially greater than the width of the legs 10 minus the width of the teeth 8. On the side located opposite the active surfaces 11 of the separating element 4, the separating element 4 is in contact with a housing surface 13 designed as an abutment. As is apparent from the sectional view in FIG. 3, the abutment and the associated surface of the separating element 4 are flat surfaces, which permit a sliding movement of the components.

The mounting bolt 2 has at least two predetermined breaking points, which may be designed as undercuts. At least two sets of teeth 8 are provided on the mounting bolt 2. The translatory movement of the separating element 4 is transmitted via the teeth 9 of the separating element 4 to the teeth 8 of the mounting bolt 2 in the case of a crash, and the translation is transformed into a rotation, and a directed rotary movement of the connecting piece 1 in the direction of the floor of the vehicle is thus achieved.

While a specific embodiment of the invention has been shown and described in detail to illustrate the application of the principles of the invention, it will be understood that the invention may be embodied otherwise without departing from such principles.

1-9. (Canceled)

10. A safety device for opening a mount with a first mounting part having at least one through hole for a bolt connection and with at least one connecting piece, as well as at least one mounting bolt, which extends coaxially through the through hole in order to connect the mounting part and the connecting piece to one another, safety device comprising:
moving means for moving said connecting piece out of a danger area in a directed manner in the direction of the front of the vehicle; and
separating means for destroying the mounting bolt for opening the mount and for separating the connecting piece, said moving means and said separating means comprising at least one separating element supported via a support part and accommodated and guided between the connecting piece and the mounting part in order to destroy the mounting bolt and thus to separate it from the mount upon the onset of a collision.

11. A safety device in accordance with claim 10, wherein said support part is a cross rail of the vehicle, which moves away from its initial position only very slightly if at all as a consequence of a collision.

12. A safety device in accordance with claim 10, wherein the flow of forces between said separating element and said mounting bolt for destroying said mounting bolt is embodied by means of at least one active surface, whose contour corresponds to the principle of action of an oblique plane and said separating element is a separating wedge.

13. A safety device in accordance with claim 10, wherein said connecting piece is a pedal lever of a motor vehicle.

14. A safety device in accordance with claim 13, wherein said pedal lever is a brake pedal or a clutch pedal.

15. A safety device in accordance with claim 10, wherein said mounting part is a plastic bearing block having at least two legs for guiding said separating element.

16. A safety device in accordance with claim 10, wherein the positive-locking connection between said separating element and said mounting bolt for moving away the connecting piece in a directed manner is embodied by means of teeth.

17. A safety device in accordance with claim 10, wherein said mounting bolt has undercuts designed as predetermined breaking points.

18. A safety device in accordance with claim 10, wherein contact between said separating element and the mounting bolt are via a positive-locking connection and a nonpositive connection established one after another, wherein said separating element first moves the connecting piece in a direction of a floor of a connected vehicle via positive-locking teeth in the case of a collision before the mounting bolt is destroyed via active surfaces of said separating element.

19. A motor vehicle pedal bolt mount with safety device, comprising:
a first mounting part having a through hole;
a connection piece;
a mounting bolt connecting said connection piece to said first mounting part, said mounting bolt extending coaxially through said through hole in order to connect said mounting part and said connecting piece to one another via a bolt connection;
moving means for moving said connecting piece out of a danger area in a directed manner in the direction of the front of the vehicle; and
separating means for destroying said mounting bolt and for separating the connecting piece, said moving means and said separating means comprising at least one separating element supported via a support part and accommodated and guided between said connecting piece and said mounting part in order to destroy said mounting bolt and thus to separate it from the mounting part upon the onset of a collision.

20. A motor vehicle pedal bolt mount with safety device in accordance with claim 19, wherein said support part is a cross rail of the vehicle, which moves away from its initial position only very slightly if at all as a consequence of a collision.

21. A motor vehicle pedal bolt mount with safety device in accordance with claim 19, wherein the flow of forces between said separating element and said mounting bolt for destroying said mounting bolt is embodied by means of at least one active surface, whose contour corresponds to the principle of action of an oblique plane and said separating element is a separating wedge.

22. A motor vehicle pedal bolt mount with safety device in accordance with claim 19, wherein said connecting piece is a pedal lever of a motor vehicle.

23. A motor vehicle pedal bolt mount with safety device in accordance with claim 22, wherein said pedal lever is a brake pedal or a clutch pedal.

24. A motor vehicle pedal bolt mount with safety device in accordance with claim 19, wherein said mounting part is a plastic bearing block having at least two legs for guiding said separating element.

25. A motor vehicle pedal bolt mount with safety device in accordance with claim 19, wherein the positive-locking connection between said separating element and said mounting bolt for moving away said connecting piece in a directed manner is embodied by means of teeth.

26. A motor vehicle pedal bolt mount with safety device in accordance with claim 19, wherein said mounting bolt has undercuts designed as predetermined breaking points.

27. A motor vehicle pedal bolt mount with safety device in accordance with claim 19, wherein contact between said separating element and said mounting bolt are via a positive-locking connection and a nonpositive connection established one after another, wherein said separating element first moves said connecting piece in a direction of a floor of a connected vehicle via positive-locking teeth in the case of a collision before said mounting bolt is destroyed via active surfaces of said separating element.
